(19) United States
(12) Patent Application Publication
(10) Pub. No.: US 2025/0333244 A1
(43) Pub. Date: Oct. 30, 2025

(54) REFUSE LOADING SYSTEM WITH REMOVABLE CAN

(71) Applicant: The Heil Co., Chattanooga, TN (US)

(72) Inventors: Mark Fraas, Centre, AL (US); Bryan Kelly Stewart, Chattanooga, TN (US); Ethan Lee Maness, Rainsville, AL (US)

(21) Appl. No.: 19/189,067

(22) Filed: Apr. 24, 2025

Related U.S. Application Data
(60) Provisional application No. 63/637,990, filed on Apr. 24, 2024.

(51) Int. Cl. B65F 3/04; B65F 1/12; B65F 3/02

(52) U.S. Cl. CPC B65F 3/041; B65F 1/122; B65F 2003/0279

(57) ABSTRACT

An intermediate refuse collection system includes a support structure, a removable collection bin coupled to the support structure, a refuse loading mechanism coupled to the support structure, and a control system. The support structure includes a base. The base is configured to couple with a lift of a refuse collection vehicle. The removable collection bin includes a polymeric material. The is operable to transfer refuse into the removable collection bin. The control system is configurable to operate the refuse loading mechanism. One or more power supply devices are coupled to the support structure and configured to supply power to the refuse loading mechanism.

### CROSS-REFERENCE TO RELATED APPLICATIONS

This application claims the benefit under 35 U.S.C. § 119(e) of U.S. Patent Application No. 63/637,990, entitled “Refuse Loading System With Removable Can,” filed Apr. 24, 2024, which is incorporated herein by reference in its entirety.

### BACKGROUND

Refuse collection vehicles are typically used to pick up quantities of refuse for hauling to a determined area, such as a landfill, transfer station, or material recovery facility. Refuse collection vehicles are sometimes modified to collect recyclables or other materials for transport.

Some refuse collection systems use large trucks having compaction capabilities, extending their effective range and capacity between unloading's. The refuse collection vehicles can include collection/intermediate containers (or “cans”). The intermediate container allows a refuse vehicle designed for the collection of large waste containers, such as dumpsters, to collect smaller, non-commercial waste containers.

### SUMMARY

Implementations of the present disclosure are generally directed to refuse handling systems for refuse collection vehicles and methods of operating such systems.

In a general aspect of the disclosure, an intermediate refuse collection system, includes a support structure, a removable collection bin coupled to the support structure, and a refuse loading mechanism coupled to the support structure, and control system coupled to the support structure, and one or more power supply devices coupled to the support structure. The support structure including a base, the base is configured to couple with a lift of a refuse collection vehicle. The removable collection bin is coupled to the support structure, the removable collection bin including a polymeric material. The refuse loading mechanism is operable to transfer refuse into the removable collection bin. The control system is configurable to operate the refuse loading mechanism. The one or more power supply devices coupled to the support structure and configured to supply power to the refuse loading mechanism.

In some implementations, the refuse loading mechanism includes one or more electric drive units; and at least one of the power supply devices includes a battery configured to supply electric power to at least one of the electric drive units.

In some implementations, the refuse loading mechanism is configured to lift a waste container and empty contents of the waste container into the removable collection bin.

In some implementations, the base includes one or more pockets; and each of at least two of the pockets is configured to receive a fork of the lift.

In some implementations, the lift includes a front-end loading arm assembly configured to empty contents of the removable collection bin into a vehicle container.

In some implementations, the system includes a propping device configured to raise at least a portion of the base off the ground when the base is resting on the ground.

In a general aspect of the disclosure, a method of collecting refuse, includes: operating a refuse collection vehicle to engage a base of an intermediate refuse collection system with a lift of the refuse collection vehicle; supplying electric power from the intermediate refuse collection system to a refuse a refuse loading mechanism of the intermediate refuse collection system; and operating the refuse loading mechanism to load refuse into a removable collection bin coupled to the base.

In some implementations, at least a portion of the removable collection bin includes a polymeric material.

In some implementations, the method further includes operating the lift to transfer contents from the removable collection bin into a vehicle container.

In some implementations, the method further includes removing the removable collection bin from the base and replacing the removable collection bin with another collection bin

In some implementations, the method further includes, before engaging the base with the lift, operating a propping device to prop at least a portion of the base above a ground surface.

In some implementations, the method further includes disengaging the base from the lift of the refuse collection vehicle.

In some implementations, the method further includes, before disengaging the base from the lift, operating a propping device to prop at least a portion of the base above a ground surface.

In some implementations, the method further includes, after disengaging the base from the lift, operating the refuse loading mechanism.

In a general aspect of the disclosure, a refuse collection system includes a support structure including a base, a removable collection bin, and a refuse loading mechanism. The base is configured to couple with a lift of a refuse collection vehicle. The removable collection bin is coupled to the support structure. The refuse loading mechanism is coupled to the support structure, the refuse loading mechanism configured to transfer refuse into the removable collection bin.

In some implementations, the removable collection bin includes one or more walls including a polymeric material.

In some implementations, refuse loading mechanism is configured to lift a waste container and empty contents of the waste container into the removable collection bin.

In some implementations, the container lift mechanism is configured to lift the removable collection bin and transfer contents of the removable collection bin into a container on the refuse collection vehicle.

In some implementations, the vehicle is a front-loading refuse collection vehicle, the removable collection bin is an intermediate container, and the container lift mechanism includes two or forks configured to couple with the base.

In some implementations, the system further includes a control system coupled to the support structure and configurable to operate the refuse loading mechanism to load refuse into the removable collection bin, and one or more power supply devices coupled to the support structure and configured to supply power to the refuse loading mechanism.

In some implementations, at least one of the power supply devices or one or more components of the control system are coupled to the base under at least a portion of the removable collection bin.

In some implementations, the collection bin is configured to tilt forward to enable access one or more of the power supply devices or one or more components of the control system.

In some implementations, the removable collection bin includes one or more contours configured to accommodate one or more of the power supply devices or one or more components of the control system.

In some implementations, the removable collection bin is at least partially produced by rotational molding.

In some implementations, the system further includes a collection bin tilt mechanism coupled between the base collection bin and the base.

In some implementations, the removable collection bin includes a notch configured to engage on a portion of the base.

In some implementations, the system further includes one or more skid pads removably coupled to the base.

In some implementations, the base includes two or more sockets configured to receive at least a portion of the removable collection bin.

In some implementations, the base includes a socket configured to receive at least a portion of the removable collection bin.

In some implementations, the support structure further includes a frame extending upwardly from the base, and at least one component of the refuse loading mechanism is coupled to the frame.

In some implementations, the refuse loading mechanism includes a reciprocating member configured to move in and out with respect to the support structure.

In a general aspect of the disclosure, an intermediate refuse collection system, includes a support structure including a base, the base configured to couple with a lift of a refuse collection vehicle, and a removable collection bin coupled to the support structure, the removable collection bin including a polymeric material.

In some implementations, the base includes a steel frame.

In some implementations, the removable collection bin is at least partially produced by rotational molding.

In some implementations, the system further including a bin tilt mechanism coupled between the removable collection bin and the base.

In a general aspect of the disclosure, an intermediate refuse collection system, includes a support structure, a removable collection bin coupled to the support structure, and a refuse loading mechanism coupled to the support structure, and control system coupled to the support structure, and one or more power supply devices coupled to the support structure. The support structure includes a base. The base is configured to couple with a lift of a refuse collection vehicle. a removable collection bin coupled to the support structure. The refuse loading mechanism operable to transfer refuse into the collection bin. The control unit is configurable to operate the refuse loading mechanism. The one or more power supply devices coupled to the support structure and configured to supply power to the refuse loading mechanism.

In some implementations, the refuse loading mechanism includes one or more electric drive units.

In some implementations, the refuse loading mechanism includes one or more hydraulic drive units, and at least one of the power supply devices is configured to supply electrical power to the refuse loading mechanism to operate at least one of the hydraulic drive units.

In a general aspect of the disclosure, an intermediate refuse collection system, includes a support structure including a base, the base configured to couple with a lift of a refuse collection vehicle; a collection bin coupled to the support structure; and a propping device configured to prop at least a portion of the base off the ground when the base is resting on the ground.

In some implementations, the system further includes a propping device coupled to the base, wherein the propping device is operable by a user to raise at least a portion of the base off the ground.

In some implementations, the propping device includes one or more retractable support brackets.

In some implementations, the system further includes a drive unit configured to move at least one of the one or more retractable support brackets.

In some implementations, the propping device includes one or more arms configured to rotate with respect to the base such that at least a portion of the base is raised off the ground.

In some implementations, the base includes one or more pockets; and each of at least two of the pockets is configured to receive a fork of the lift.

In some implementations, the lift includes a front-end loading arm assembly configured to empty contents of the collection bin into a vehicle container.

In a general aspect of the disclosure, a method of engaging a lift of a refuse collection vehicle with an intermediate collection system, includes operating a propping device on coupled to a base of the intermediate collection system to raise at least a portion of the base off the ground; and operating, while the propping device holds the at least a portion of the base off the ground, the refuse collection vehicle to engage the lift with the base.

In some implementations, the method further includes raising at least a portion of the base off the ground includes inclining the base at an angle relative to the ground.

Particular implementations of the subject matter described in this specification can be implemented so as to realize one or more of the following advantages.

Implementations of the present disclosure may make it easier to couple and decouple intermediate containers from a refuse collection vehicle. For example, implementations of the present disclosure may reduce or eliminate a need to make fluid, electrical power, or control connections between a refuse loading mechanism and a refuse collection vehicle.

Implementations of the present disclosure may make intermediate refuse collection systems easier to maintain. For example, implementations of the present disclosure allow for removal and replacement of a collection bin without removing other components.

Implementations of the present disclosure may make collection of refuse more energy-efficient.

Implementations of the present disclosure may reduce the need for heavy components with high maintenance costs.

Implementations of the present disclosure may make it easier for a refuse collection vehicle to switch between modes of operation (e.g., between commercial pick-up and residential pick-up).

Implementations of the present disclosure may allow an intermediate refuse collection system to be operated without relying on power from the refuse collection vehicle on which it is carried.

Implementations of the present disclosure may allow stand-alone operation of a refuse loading system (e.g., without being installed on a refuse collection vehicle.)

Implementations of the present disclosure may facilitate the use of the different types of collection bins on the same intermediate collection platform.

Implementations of the present disclosure may increase reliability, sustainability, and effectiveness of a refuse collection system.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 illustrates a refuse collection vehicle on which systems and methods as described herein can be implemented.

FIG. 2 is a driver-side front perspective view of an intermediate refuse collection system according to some implementations.

FIG. 3 is a curb-side front perspective view of an intermediate refuse collection system according to some implementations.

FIG. 4 is a driver-side rear perspective view of an intermediate refuse collection system according to some implementations.

FIG. 5 illustrates an intermediate refuse collection system with a collection bin tilted forward.

FIG. 6 illustrates an intermediate refuse collection system with a collection bin removed from a support structure.

FIG. 7 is a front perspective view illustrating an intermediate refuse collection system from below.

FIG. 8 is a curb-side cross-sectional view of an intermediate refuse collection system according to some implementations.

FIG. 9 illustrates an intermediate refuse collection system with a collection bin is a tilted-forward position.

FIG. 10 illustrates a propping device including a folding support structure according to some implementations.

FIG. 11 is a side view illustrating a propping device with retractable support brackets according to some implementations.

FIG. 12 is a perspective view of a propping device with retractable support brackets according to some implementations.

FIGS. 13A and 13B illustrates a collection bin that includes a removable side panel.

FIG. 14 depicts an example computing system, according to implementations of the present disclosure.

### DETAILED DESCRIPTION

Implementations of the present disclosure are directed to systems, devices, and methods for collecting refuse.

Some implementations include an intermediate refuse collection system that has a support structure, a removable collection bin, and a refuse loading mechanism. The removable collection bin can be made of a polymeric material (e.g., rotomolded plastic). The removable collection bin and the refuse loading mechanism are mounted on the support structure. The support structure includes a base that can receive forks of a lift mechanism of a refuse collection vehicle. The refuse loading mechanism includes electric motors for moving components of the mechanism. The refuse loading mechanism is powered by an electric power source (e.g., a bank of batteries) that is mounted on the support structure. The refuse loading mechanism can be operated to load refuse into the removable collection bin.

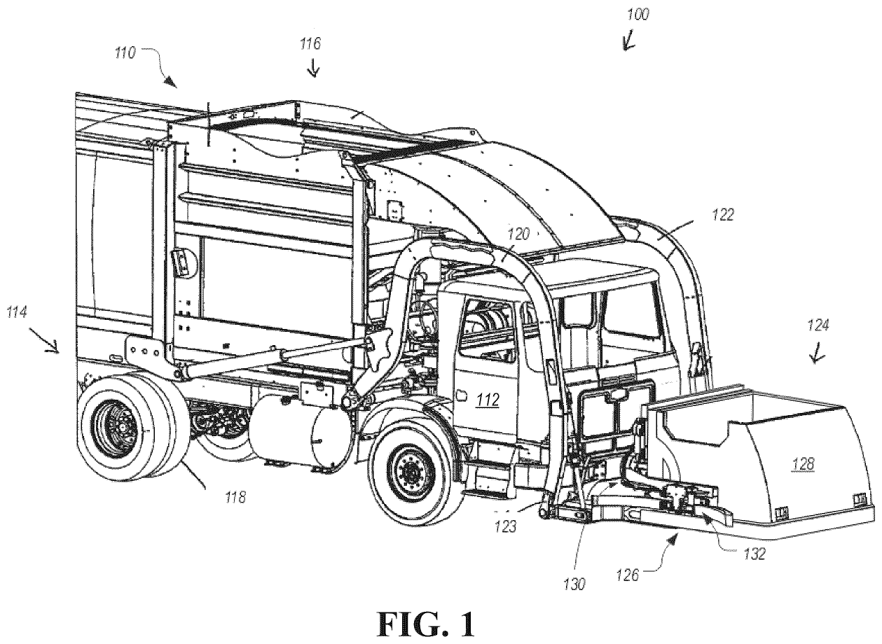

FIG. 1 illustrates a refuse collection vehicle on which systems and methods as described herein can be implemented. Refuse collection system 100 includes refuse collection vehicle 110. Refuse collection vehicle 110 includes cab 112, chassis 114, and primary container 116. A drivetrain including wheels 118 moves the refuse collection vehicle 110.

Refuse collection vehicle 110 includes intermediate refuse collection system 124. Refuse collection vehicle 110 includes a front-loading arm assembly having a pair of front-loading arms 120, 122. Front-loading arms 120, 122 may have an overall U-shaped configuration. The arms may terminate at connection end 123. In some implementations, the intermediate refuse collection system 124 is pivotally coupled at the connection end 123. Lift cylinders are connected between the arm bosses and the front-loading arms 120, 122.

Intermediate refuse collection system 124 includes support structure 126, collection bin 128, and refuse loading mechanism 130. Front-loading arms 120, 122 are coupled between refuse collection vehicle 110 and intermediate refuse collection system 124. Support structure 126 is coupled to front-loading arms 120, 122. In some implementations, support structure 126 is mounted on refuse collection vehicle 110 by way a fork on a loading mechanism of the refuse collection vehicle.

Refuse loading mechanism 130 includes grabber device 132. Grabber device 132 can be operated to grab residential-sized containers (e.g., curb-side containers) and load the contents of the residential-sized container into collection bin 128.

In some implementations, refuse loading mechanism 130 is used to load refuse into collection bin 128 of intermediate refuse collection system 124. Intermediate refuse collection system 124 can be used to receive refuse from one or more curb-side containers at repeated stops along a refuse collection route. Subsequently, front-loading arms 120, 122, support structure 126, and collection bin 128 can be lifted and rotated to dump the refuse that has been received into collection bin 128 into primary container 116.

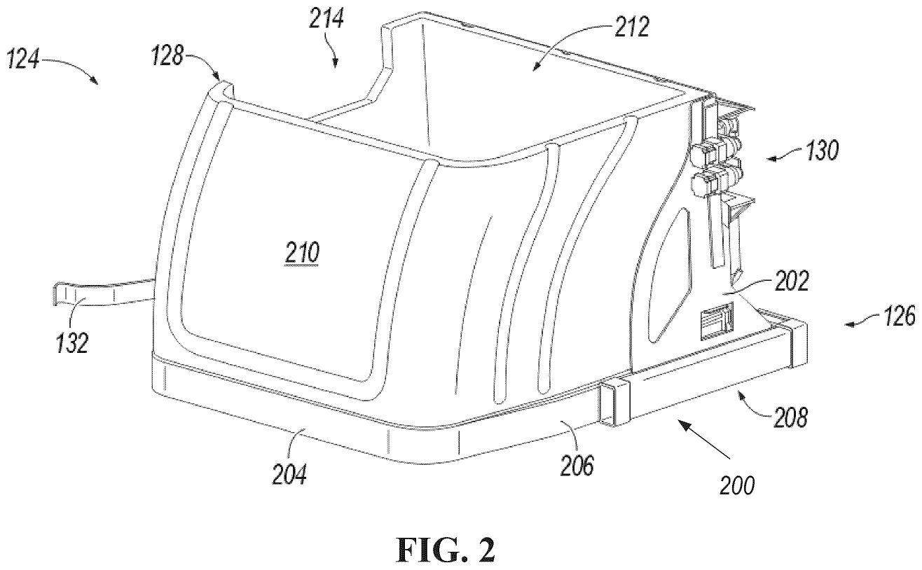

FIG. 2 is a driver-side front perspective view of an intermediate refuse collection system according to some implementations. Intermediate refuse collection system 124 can be installed on a vehicle, such as refuse collection vehicle 110 described above relative to FIG. 1. Intermediate refuse collection system 124 includes support structure 126, collection bin 128, and refuse loading mechanism 130. Support structure 126 includes base 200 and frame 202. Frame 202 extends upwardly (e.g., vertically) from base 200. Base 200 includes front rail 204, side rails 206, and fork-receiving members 208. One of side rails 206 and one of the fork-receiving members 208 is included on either side of support structure 126. Collection bin 128 mounts on front rail 204 and side rails 206 of base 200.

Collection bin 128 includes body 210. Body 210 defines refuse collection volume 212 and receiving slot 214. Collection bin 128 is removable from support structure 126.

In some implementations, at least a portion of collection bin 128 (e.g., body 210) is made of a polymeric material. Examples of polymers that can be used include polyethylene, polyolefin, polyvinyl chloride, nylon, polypropylene, or polycarbonate. In some implementations, a collection bin is made of fiberglass. In some implementations, a collection bin is rotationally molded (e.g., rotomolded).

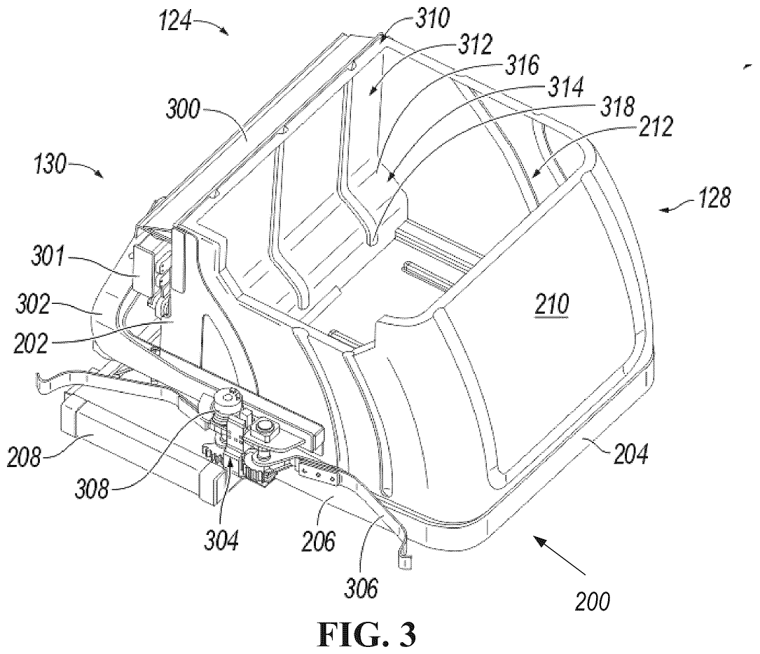

FIG. 3 is a curb-side front perspective view of an intermediate refuse collection system according to some implementations. Intermediate refuse collection system 124 includes support structure 126, collection bin 128, and refuse loading mechanism 130. Support structure 126 includes base 200 and frame 202. Frame 202 extends upwardly (e.g., vertically) from base 200. Base 200 includes front rail 204, side rails 206, and fork-receiving members 208. Collection bin 128 mounts on front rail 204 and side rails 206 of base 200.

Loading mechanism mounting assembly 300 is installed on frame 202 of support structure 126. Refuse loading mechanism 130 includes slider beam 301, lift arm 302, and grabber device 132. Slider beam 301 is translatably coupled to loading mechanism mounting assembly 300. Lift arm 302 is coupled to slider beam 301. Grabber device 132 is coupled to lift arm 302.

Refuse load mechanism 130 can be operated to translate slider beam 301 in and out on loading mechanism mounting assembly 300, thereby moving lift arm 302 and grabber device 132 closer to, or farther away from, collection bin 128.

Grabber device 132 includes grabber drive unit 304 and grabber arms 306. Grabber drive unit 304 includes electric motor 308. Grabber drive unit 304 can be operated to move grabber arms 306 to couple with residential-sized refuse containers. Lift arm 302 can be operated to empty the contents of a residential-sized container into collection bin 128.

Body 210 of collection bin 128 includes rear wall 310. Rear wall 310 includes upper section 312 and lower section 314. Lower section 314 can be contoured to create space on the outside of collection bin 128. In the example shown in FIG. 3, lower section 314 includes angled panel 316 and base panel 318. Base panel 318 is offset inwardly in collection bin 128 relative to upper section 312 of rear wall 310. The offset of base panel 318 reduces the size of the floor of collection bin 128. At the same time, the offset creates space on the outside of collection bin 128. The offset can be used to accommodate components of refuse loading mechanism 130.

In the example shown in FIG. 3, the collection bin is contoured on the rear of the collection bin. In other implementations, a collection bin includes contours in other locations that create space under portions of the collection bin. For example, a collection bin can include a contour on one or both sides of the bin, in the middle of the floor of the collection bin, or at the front wall of the collection bin.

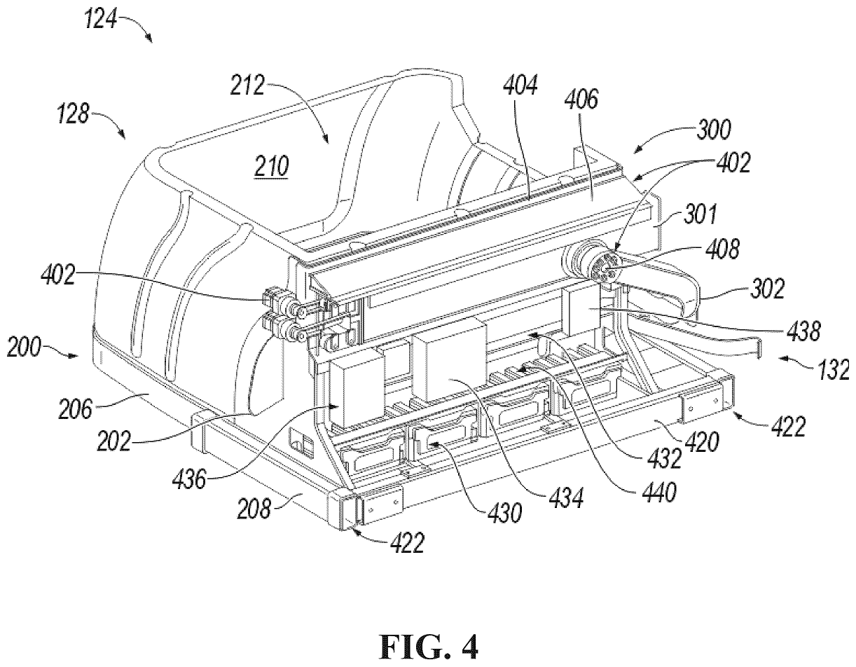

FIG. 4 is a driver-side rear perspective view of an intermediate refuse collection system according to some implementations. Intermediate refuse collection system 124 includes support structure 126, collection bin 128, and refuse load mechanism 130. Support structure 126 includes base 200 and frame 202. Frame 202 extends upwardly (e.g., vertically) from base 200. Base 200 includes side rails 206 and fork-receiving members 208. Collection bin 128 mounts on front rail 204 (shown in FIGS. 2 and 3) and side rails 206 of base 200.

Refuse loading mechanism 130 includes slider beam 301, lift arm 302, grabber device 132, horizontal drive unit 402, rail system 404, rail guard 406, and lift arm drive unit 408. Slider beam 301 is translatably coupled to load mechanism mounting assembly 300. Lift arm 302 is coupled to slider beam 301. Grabber device 132 is coupled to lift arm 302.

Rail system 404 is secured to frame 202 of support structure 126. Slider beam 301 translates on rail system 404. Horizontal drive unit 402 is operable to translate slider beam 301 back and forth on rail system 404. In the example shown in FIG. 4, horizontal drive unit 402 is a belt drive that includes a pair of electric motors.

Base 200 of support structure 126 includes rear rail 420. Rear rail 420 spans the width of base 200 between opposing sides of base 200. Rear rail 420 is attached to fork-receiving members 208. Each of fork-receiving members 208 includes a socket 422. Each of sockets 422 can receive a fork of a refuse vehicle lift mechanism, such as refuse vehicle 110.

Power, control systems, or both for refuse loading mechanism 130 can be provided on support structure 126. In this example, refuse loading mechanism 130 includes batteries 430. Batteries 430 are at least partial held in recess 432 formed in the rear wall of collection bin 128. Refuse loading mechanism 130 also include battery module system 434, charger 436, and control unit 438. Batteries 430, charger 436, and control unit 438 can be connected to one another, to drive components, and sensor components of refuse loading mechanism 130 by way of one or more cable assemblies. In some implementations, one or more components (e.g., control unit 438) are connected to other components of refuse loading mechanism 130 and/or external to refuse loading mechanism 130 by way of a wireless connection.

Batteries 430 supply power to electric motors of refuse loading mechanism 130. For example, (e.g., in horizontal drive unit 402, lift arm drive unit 408, and grabber device drive unit 304 (shown in FIG. 3)). Control unit 438 is communicatively coupled to battery module system 434 and charger 436. Control unit 438 can be used to operate electric motors on refuse loading mechanism 130 to load refuse into collection bin 128. Battery module system 434 and charger 436 are mounted on shelf 440. Shelf 440 can be attached to base 200.

In some implementations, control unit 438 is communicatively coupled to a device controlled by a user. The device can be, for example, a user control device in the cab of refuse collection vehicle 110. The connection between control systems on intermediate refuse collection system 124 to external control devices can be wired, wireless, or combinations thereof.

Charger 436 can be coupled with power supply devices external to intermediate refuse collection system 124. As one example, charger 436 of intermediate refuse collection system 124 can be coupled to a power supply station after the intermediate refuse collection system 124 has been dropped off from the refuse collection vehicle. In some implementations, a charger external to the intermediate refuse collection system and/or the refuse collection vehicle (e.g., a fixed charging station) is used to provide power to batteries 430 (e.g., without using a charger on board the intermediate refuse collection system).

In some implementations, batteries 430 for intermediate refuse collection system 124 are charged using electric power provided by the refuse collection vehicle. In certain implementations, a refuse collection mechanism of an intermediate refuse collection system is powered by a power supply external to the intermediate refuse collection system. In one implementation, for example, an intermediate refuse collection system is auxiliary power from the engine of the refuse collection vehicle.

Lift arm 302 is rotatably coupled to slider beam 301. Lift arm drive unit 408 includes an electric motor. Lift arm drive unit 408 is operable to swing lift arm 302 upward. Lift arm drive unit 408 can be operated to raise grabber device 132 and a residential sized container held in grabber device to empty the contents of the container into collection bin 128.

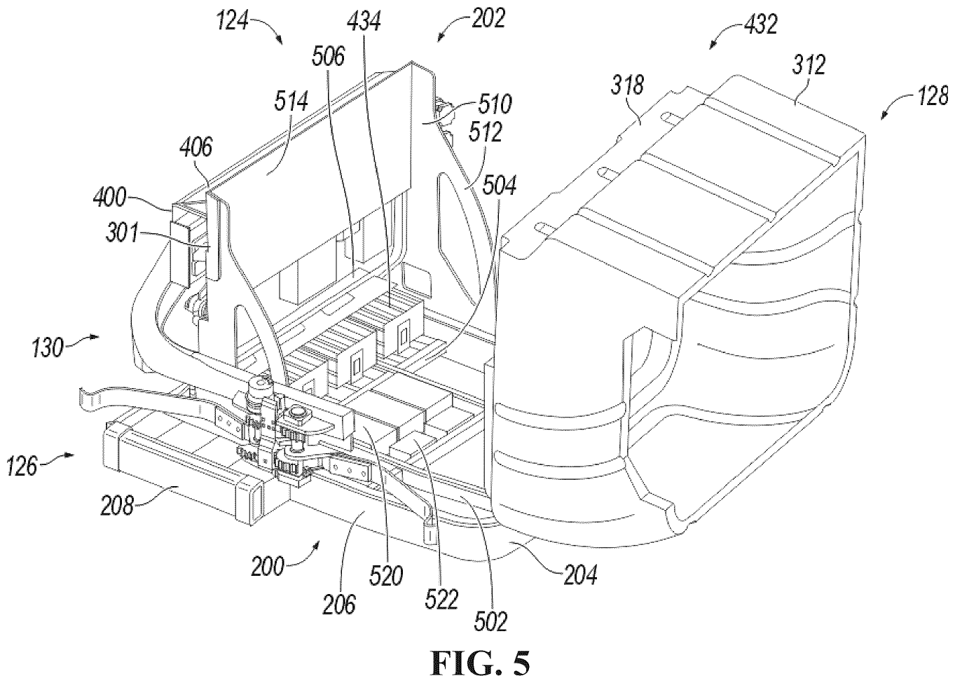

FIG. 5 illustrates an intermediate refuse collection system with a collection bin tilted forward. Intermediate refuse collection system 124 includes support structure 126, collection bin 128, and refuse load mechanism 130. Support structure 126 includes base 200 and frame 202. Frame 202 extends upwardly (e.g., vertically) from base 200. Base 200 includes side rails 206 and fork-receiving members 208. Collection bin 128 mounts on front rail 204 and side rails 206 of base 200.

Base 200 includes interior rails 502 and cross members 504. Interior rails 502 can span from front rail 204 to rear rail 420 (shown in FIG. 4). Cross members 504 span between opposing side rails 206. Interior rails 502 and cross members 504 provide structural reinforcement to base 200. Interior rails 502 and cross members 504 serve as structural elements for mounting components under collection bin 128. In this example, converters 520 and motor controller 522 are mounted on base 200 between two of interior rails 502 and two of cross members 504.

Frame 202 includes side frame member 510, forward brace 512, and main cross member 514. Main cross member 514 spans between opposing side frame members 510. Forward braces 512 stiffen frame 202.

The offset between upper section 312 and base panel 318 defines a recess 432 near the bottom of collection bin 128. Recess 432 is a space outside collection bin 128 that can accommodate components of intermediate refuse collection system 124 when collection bin 128 is lowered into its rest position on base 200. In this example, recess 432 at least partially accommodates batteries 430.

The location of batteries 430 and other components in recess 432 provides protection to the components from environmental conditions such as rain, snow, and dust. The location of motor controllers 522 and converters 520 under the floor of collection bin 128 provides protection to the components from environmental conditions such as rain, snow, and dust.

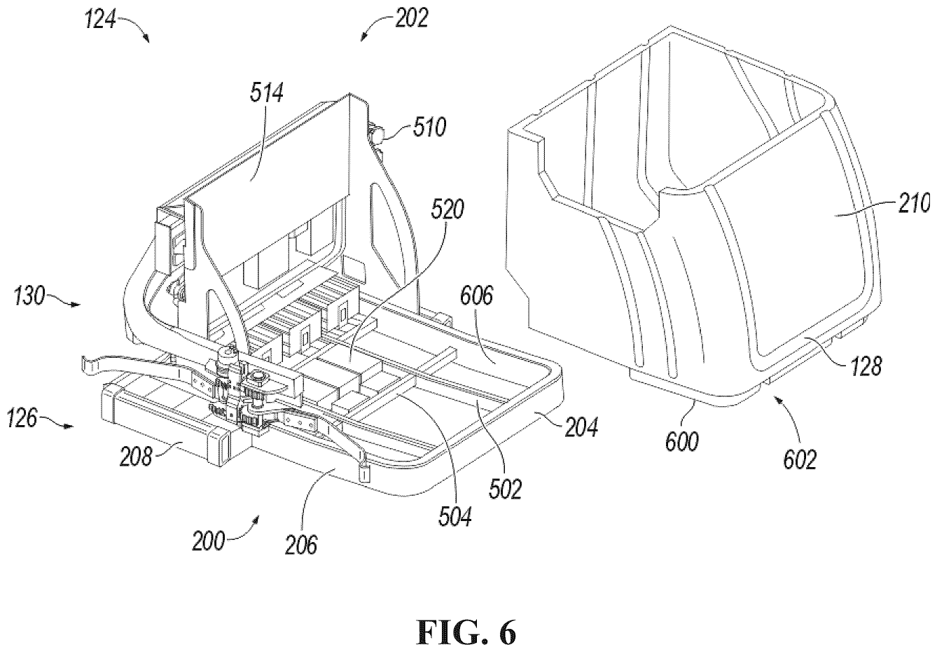

FIG. 6 illustrates an intermediate refuse collection system with a collection bin removed from a support structure. Collection bin 128 includes body 210 and bottom portion 600. The edges of bottom portion 600 are inset from sides of body 210 such that notch 602 is defined along the front and forward bottom edges of collection bin 128. Collection bin 128 may nest on base 200 at the inner edges 606 of front rail 204 and side rails 206.

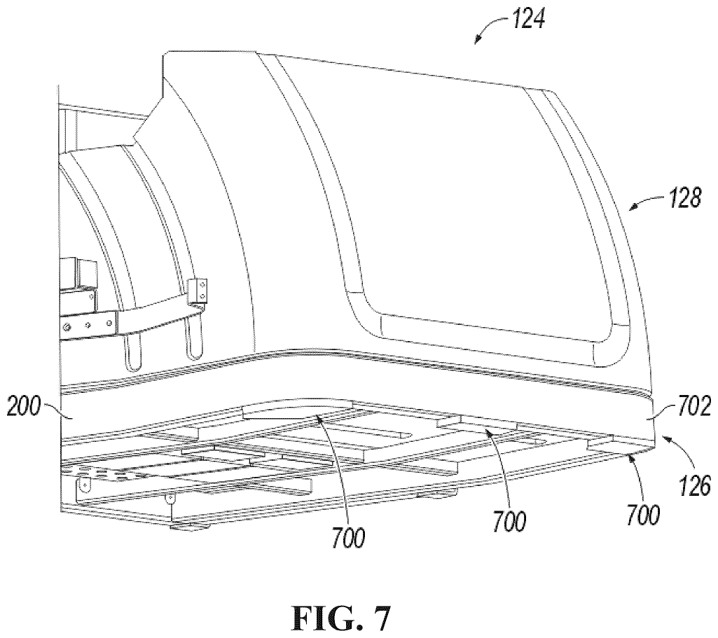

FIG. 7 is a front perspective view illustrating an intermediate refuse collection system from below. Support structure 126 includes skid pads 700. Skid pads 700 may protect intermediate refuse collection system in the case of contact with the ground while a refuse collection vehicle is in motion, or during loading and unloading of the intermediate refuse collection system. Skid pads 700 can be removable and replaceable.

In this example, one skid pads 700 is located on each of the forward corners 702 of base 200, and a third skid pad 700 is located midway between the corner skid pads. In other implementations, an intermediate refuse collection system includes another number of skid pads (e.g., two skid pads, or four or more skid pads) and/or the skid pads are in other locations.

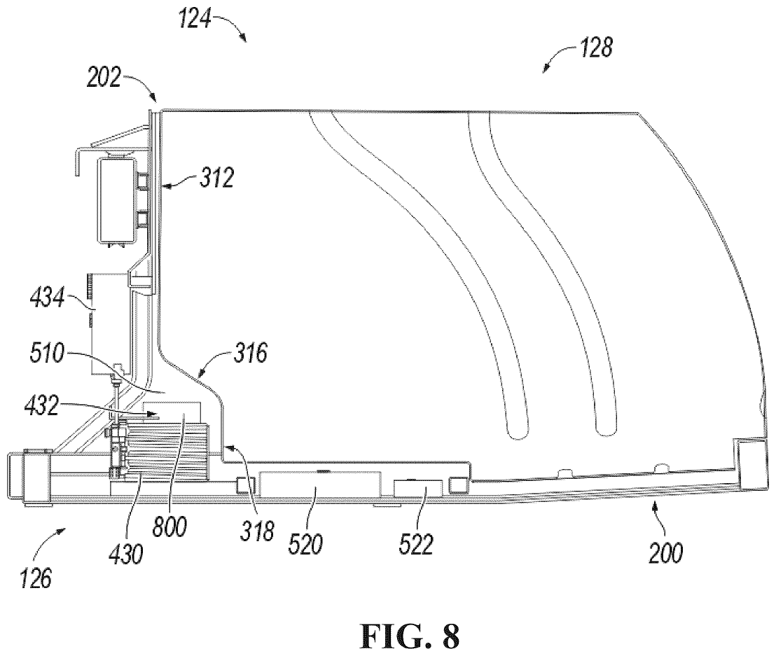

FIG. 8 is a curb-side cross-sectional view of an intermediate refuse collection system according to some implementations. Intermediate refuse collection system 124 includes collection bin 128, support structure 126, and refuse loading mechanism 130. Collection bin 128 is supported on support structure 126.

The offset between rear wall 312 and base panel 318 define a recess 432 near the bottom of collection bin 128. Recess 432 is a space outside collection bin 128 that can accommodate components of intermediate refuse collection system 124 when collection bin 128 is lowered into its rest position on base 200. In this example, recess 432 at least partially accommodates batteries 430. The location of batteries 430 and other components in recess 432 or under the floor of collection bin 128 also provides protection to the batteries from environmental conditions such as rain, snow, and dust.

Side frame member 510 includes access opening 800. Access opening 800 can be used to obtain access to components mounted on base 200 or frame 202. An access opening can be provided on both the left and right sides of intermediate refuse collection system 124. In some implementations, covers are provided over the access openings to protect components from environmental conditions.

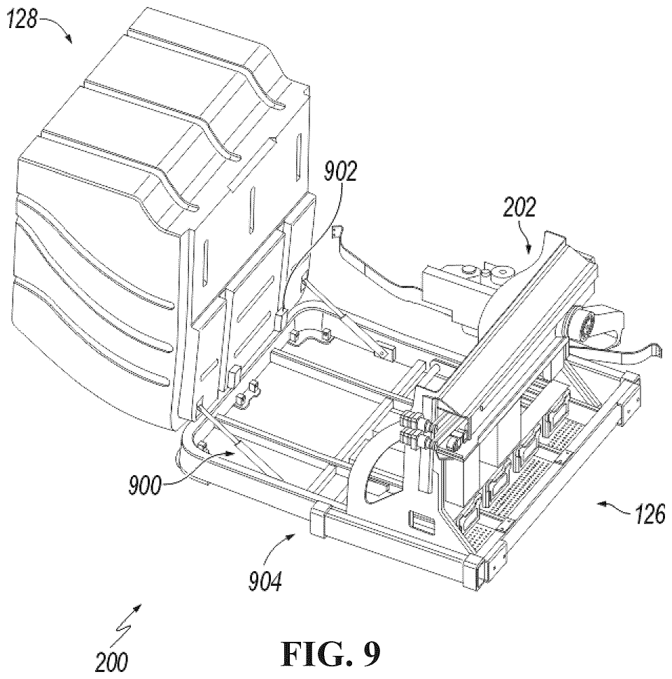

In some implementations, a system includes devices for positioning or orienting a collection bin on a base. FIG. 9 illustrates an intermediate refuse collection system with a collection bin is a tilted-forward position. Intermediate refuse collection system 124 includes bin lifting devices 900. Bin lifting devices 900 can be extended to maintain collection bin 128 in an upright position. Examples of bin lifting devices include a gas spring, an actuator, or a locking bracket.

In this example, intermediate refuse collection system 124 includes hinge devices 902 between collection bin 128 and base 200. Hinge devices 902 may include complementary hinge elements that are separable from one another (e.g., by a pin and socket arrangement) so that collection bin 128 can be completely removed from support structure 126 (e.g., for replacement with another collection bin).

In some implementations, an intermediate refuse collection system includes a propping device. The propping device can prop a portion of the base of the ground when the base is resting on the ground. In some implementations, the propping device is operable by a user to raise the portion of the base off the ground. The propping device can be used to position or orient fork-receiving members of the base to facilitate engagement of the intermediate refuse collection system with the refuse collection vehicle, or to facilitate disengagement of the intermediate refuse collection system from the refuse collection vehicle.

In some implementations, a propping device is used to facilitate engagement of an intermediate refuse collection system with a refuse collection vehicle or disengagement of the intermediate refuse collection system with a refuse collection vehicle collection vehicle. The propping device can be coupled to, or a component of, the intermediate refuse collection system. In some implementations, the propping device is operated to raise one end of the base off the ground. In some examples, the intermediate refuse collection system is propped such that the base of the intermediate refuse collection system is inclined at an angle with respect to the ground. The angle of inclination can be chosen such that the angle of a pocket of a fork-receiving member (e.g., pocket 904) is matched with the angle of a fork of the lift. The height of a pocket of a fork-receiving member can be chosen to match the height of a fork of the lift.

While the propping device holds the end of the base off the ground, a refuse collection vehicle can be operated to engage the forks of the lift (e.g., left and right forks) with corresponding pockets (e.g., left and right pockets) on the fork-receiving members of the base such that the intermediate refuse collection system can be installed on the refuse collection vehicle. When it is time to uninstall the intermediate refuse collection system, the refuse collection vehicle can be operated to disengage the forks of the lift with corresponding pockets on the fork-receiving members of the base such that the intermediate refuse collection system is separated from the refuse collection vehicle.

In some implementations, an intermediate refuse collection system includes an articulating support structure that can be used to tilt the system for easier attachment to forks of a refuse collection vehicle lift mechanism. For example, a can may be dropped in a parking lot so a refuse collection vehicle can make a commercial pickup. After the commercial pickup, the intermediate refuse collection system can be reconnected to the refuse collection vehicle, and the vehicle can continue on a residential route.

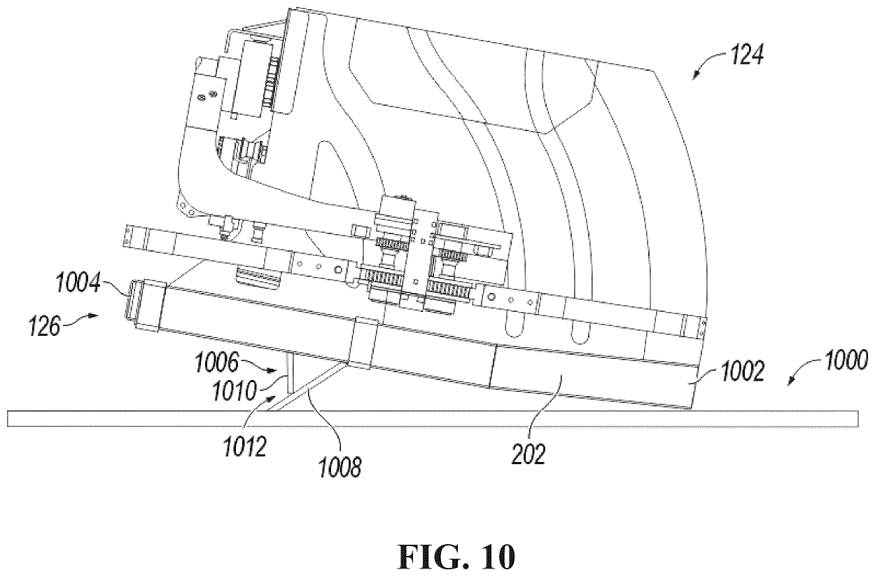

FIG. 10 illustrates a propping device including a folding support structure according to some implementations. Intermediate refuse collection system 124 rests on ground 1000. Intermediate refuse collection system 124 rests directly on ground 1000 at front end 1002. Base 200 of support structure 126 of intermediate refuse collection system 124 is propped off the ground 1000 at rear end 1004 by way of propping device 1006. Propping device 1006 includes main propping member 1008 and strut 1010. M ain propping member 1008 is coupled to base 200. In some implementations, main propping member 1008 is pivotally coupled to base 200 (e.g., one of main propping member 1008 is pivotally coupled to each of side members 206 of base 200).

Strut 1010 is coupled to main propping member 1008 at joint 1012. In some implementations, each of struts 1010 is pivotally coupled to one or more main propping members 1008 at joint 1012 and releasably coupled to one of side rails 206. In other implementations, struts 1010 are pivotally coupled to each of side rails 206 and releasably coupled to main propping member 1008. In this case, struts 1010 can be swung into engagement with one of side rails 206.

In one implementation, intermediate refuse collection system 124 includes a propping device on each of the left side and right side rails 206 of base 200. A propping device can, nevertheless, in other implementations, include members at any location on support structure 126.

In some implementations, a propping device is in the form of lifting brackets. The lifting brackets can be lowered and locked into position manually or with an automated or partially automated mechanism (e.g., a hydraulic cylinder, an electric motor, or a linear actuator).

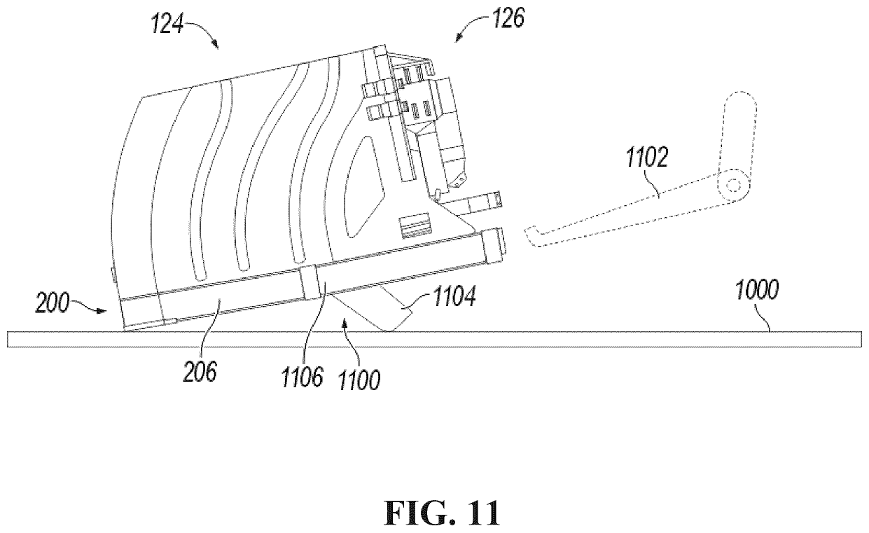

FIG. 11 is a side view illustrating a propping device with retractable support brackets according to some implementations. Intermediate refuse collection system 124 includes propping device 1100. Propping device 1100 can be operated to raise the rear end 1004 of support structure 126 to facilitate a connection with forks 1102 of a refuse collection vehicle lift mechanism. Propping device 1100 includes retractable support brackets 1104. Retractable support brackets 1104 can be pivotally coupled to base 200 at pivot joint 1106.

In some implementations, propping device 1100 is operated to position support brackets 1104 to elevate the collection bin for easy fork insertion. Once intermediate refuse collection system 124 is removed and separated from the refuse collection vehicle (e.g., dropped in a parking lot), the refuse collection vehicle can proceed to perform a commercial pick up.

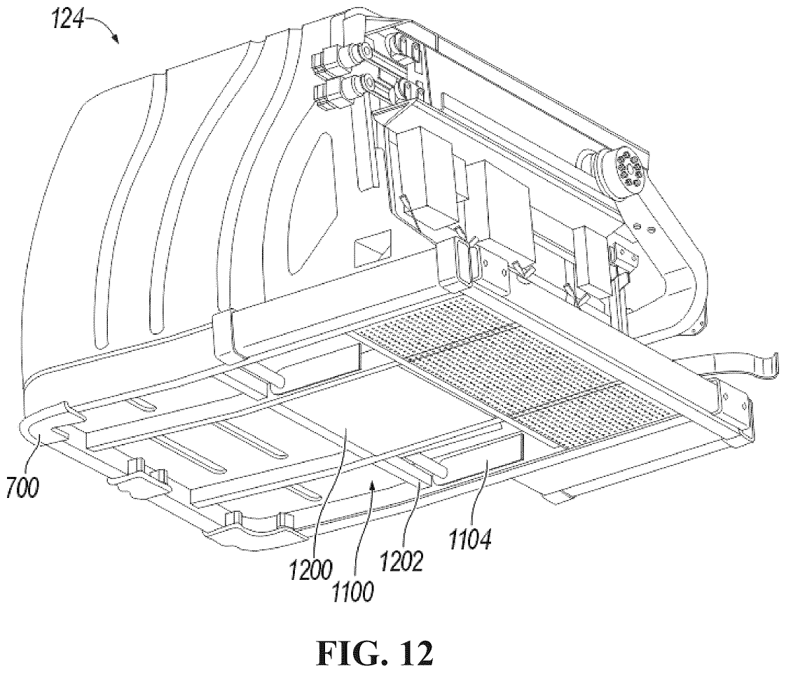

FIG. 12 is a perspective view of a propping device with retractable support brackets according to some implementations. Intermediate refuse collection system 124 includes propping device 1100. Propping device 1100 includes retractable support brackets 1104, propping device drive unit 1200, and shafts 1202. Retractable support brackets 1104 are coupled to propping device drive unit 1200 by way of shafts 1202.

In this example, intermediate refuse collection system 124 includes a pair of retractable support brackets 1104 on each side of the base 200. On each side of the base, one of the retractable support brackets 1104 adjoins the side rail, and the other retractable support bracket 1104 adjoins an interior rail.

Propping device drive unit 1200 includes a drive mechanism that can be operated to rotate shafts 1202 such that the ends of each retractable support brackets 1104 are swung downward relative to the centerline of shaft 1202. In this manner, propping device 1100 raises the rear end of base 200 off the ground.

Examples of a drive mechanism for propping device drive unit 1200 include an electric motor, a hydraulic motor, or actuator. The drive mechanism can be operably coupled to a control unit. The control unit can be used to operate propping device 1100 (e.g., to raise and lower one end of intermediate refuse collection system 124).

In some implementations, a system includes different collection bin types. Each collection bin type can have a different configuration. Each of the collection bins can be coupled on the same support structure (e.g., support structure 126 described above relative to FIGS. 1 through 6). Variations on configurations of collection bins can include the size and shape of a collection bin, the size and placement of the openings, panels, or doors of the collection bin, materials, and dimensions (e.g., wall thickness) of the body of the container, whether the collection bin has a cover, or other characteristics.

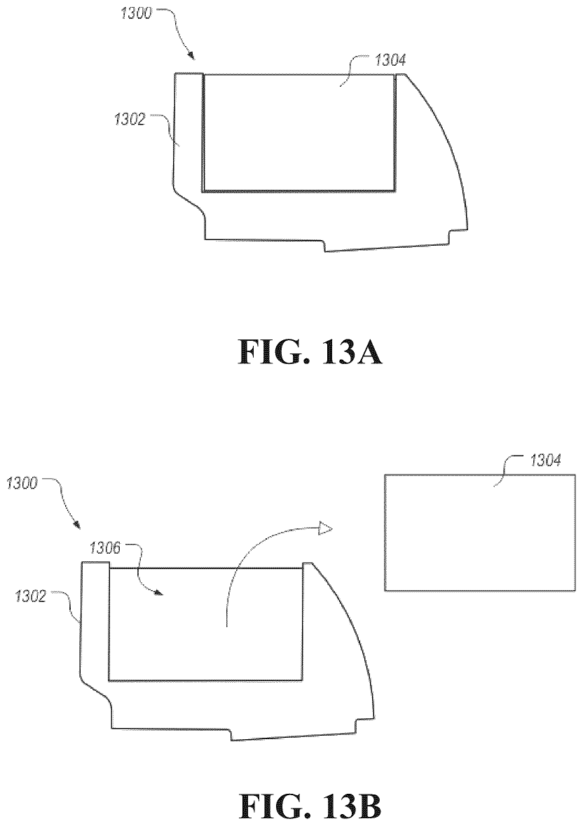

FIGS. 13A and 13B illustrates a collection bin that includes a removable side panel. Collection bin 1300 includes body 1302 and side panel 1304. Collection bin 1300 can be installed on a support structure (e.g., support structure 126 described above relative to FIGS. 1-5). Side panel 1304 can be removed from body 1302 to expose opening 1306. Opening 1306 can be used to allow loading or removal of large items. In another example, side panel 1304 is a drop-down panel.

In some implementations, a collection bin includes features for special-purpose collection and transportation. For example, a collection bin type can be made of materials and have a shape suitable for carrying hazardous materials. In some implementations, collection bin includes anti-splash guards.

In some implementations, collection bin includes a cover. The cover can be positioned manually, automatically, or a combination thereof. In certain implementations, a collection bin includes a tarping system.

In certain implementations, a refuse loading mechanism of an intermediate refuse collection system is operated while the system is not connected to a refuse collection vehicle. For example, refuse collection vehicle 110 can drop intermediate refuse collection system 124 on a paved surface such as a parking lot. Refuse loading mechanism 130 can be operated while the intermediate refuse collection system 124 is on the ground (e.g., for testing purposes).

Sensors can be included on various components of a refuse collection system, including, for example, a reciprocating member or a grabber device. A refuse collection system can include other sensors. For example, a refuse loading mechanism can include load sensors, position sensors, angle sensors, or pressure sensors. Operation of the refuse loading mechanism or other systems can be controlled based on the information provided by the sensors. In some implementations, a refuse collection system includes sensors to sense position, angle, load, or other characteristics about the system. As an example, a sensor can sense the position of a reciprocating member. As another example, a sensor can sense load imparted by a slider assembly (e.g., cantilevered load) on one or more structural elements of a guide assembly or container.

Control of systems described herein (e.g., refuse loading mechanism 130 described above relative to FIG. 3) can be carried out manually, automatically, or a combination thereof. In some implementations, a control system collects data from refuse collection system sensors and/or other operational sensors and controls the refuse collection system or other components of vehicle based on the information. For example, a control system may automatically shut down or reduce the speed of a drive system if a compression load (or another measured characteristic of the refuse vehicle's system) is outside an established range or exceeds an established threshold.

In some implementations, torque, speed, or other parameters are adjusted based on the position, load, or other characteristics of one or more members of a refuse loading mechanism. For example, in certain implementations, the torque of the motor, energy consumption, or other operating parameters are adjusted to account for different loads. Operation of loading mechanism for collecting recycled material can, for example, be different than operation of the loading mechanism for collecting trash. In some implementations, the rate of motion of the reciprocating member can be controlled. In some implementations, belt slip is monitored. In one example, belt slip is monitored using end-of-travel position/sensors.

In some implementations, a system includes interlocks to prevent unintended or un-commanded movement (e.g., operating lift/grabber with beam in parked position).

In some implementations, the control system receives position feedback from motor movement. For example, using a sensored motor in time with the belt, position of in/out can be determined mathematically from rotation/partial rotation of motor and belt pitch.

In some implementations, a drive mechanism of a propping device is coupled to a control unit. The control unit can be used to operate the propping device (e.g., propping device 1100 described above relative to FIG. 11). For example, the propping device can be operated to raise and lower one end of the base of an intermediate refuse collection system.

In various implementations described above, devices are powered electronically. In certain implementations, however, devices used to operate components of a refuse loading mechanism (such as a grabber device lift arm, or a reciprocating member of refuse collection mechanism 130) can be activated or powered in other manners, such as pneumatically, mechanically, or hydraulically.

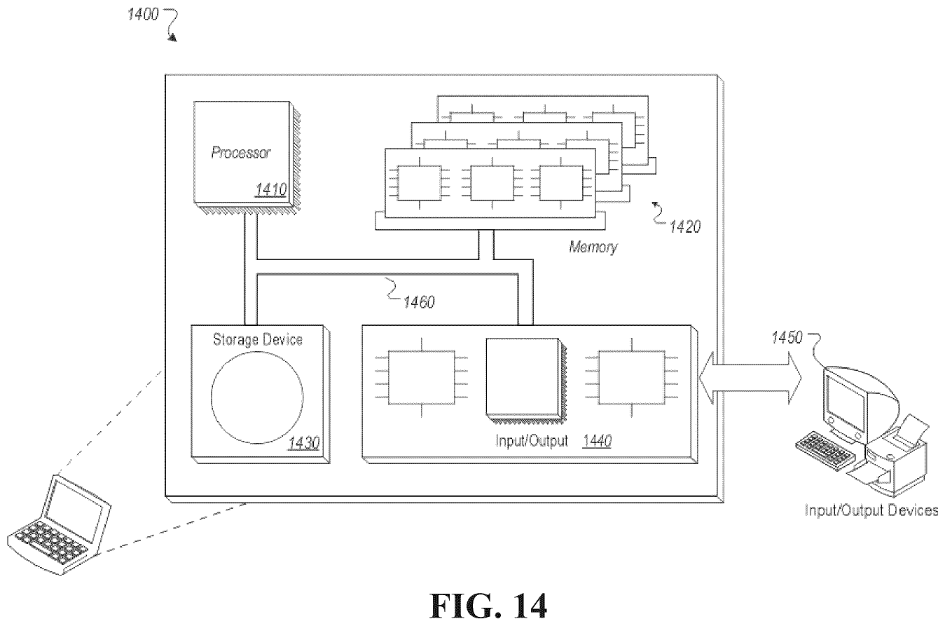

Control units and/or computing devices as described herein can include or use one or more computing systems. FIG. 14 depicts an example computing system, according to implementations of the present disclosure. The system 1400 may be used for any of the operations described with respect to the various implementations discussed herein. The system 1400 may include one or more processors 1410, a memory 1420, one or more storage devices 1430, and one or more input/output (I/O) devices 1450 controllable via one or more I/O interfaces 1440. The various components 1410, 1420, 1430, 1440, or 1450 may be interconnected via at least one system bus 1460, which may enable the transfer of data between the various modules and components of the system 1400. In some implementations, a control system may be coupled to an operator display and control panel (for example, located in a cab of the vehicle.)

The processor(s) 1410 may be configured to process instructions for execution within the system 1400. The processor(s) 1410 may include single-threaded processor(s), multi-threaded processor(s), or both. The processor(s) 1410 may be configured to process instructions stored in the memory 1420 or on the storage device(s) 1430. For example, the processor(s) 1410 may execute instructions for the various software module(s) described herein. The processor(s) 1410 may include hardware-based processor(s) each including one or more cores. The processor(s) 1410 may include general purpose processor(s), special purpose processor(s), or both.

The memory 1420 may store information within the system 1400. In some implementations, the memory 1420 includes one or more computer-readable media. The memory 1420 may include any number of volatile memory units, any number of non-volatile memory units, or both volatile and non-volatile memory units. The memory 1420 may include read-only memory, random access memory, or both. In some examples, the memory 1420 may be employed as active or physical memory by one or more executing software modules.

The storage device(s) 1430 may be configured to provide (e.g., persistent) mass storage for the system 1400. In some implementations, the storage device(s) 1430 may include one or more computer-readable media. One or both of the memory 1420 or the storage device(s) 1430 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 1400. In some implementations, the CRSM may include a data store that provides storage of computer-readable instructions or other information in a non-transitory format. The CRSM may be incorporated into the system 1400 or may be external with respect to the system 1400. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 1410 and the memory 1420 may be supplemented by, or incorporated into, one or more application-specific integrated circuits (ASICs). The system 1400 may include one or more I/O devices 1450.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an A SIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

In various implementations described above, refuse loading mechanisms have been described for use on a residential front-loader. Implementations can, however, be employed with respect to any suitable type of RCV, with any suitable type of body and/or hopper variants.

As used herein, a “drive unit” includes any device, mechanism, or system that imparts force to mechanically drive one or more components. Examples of a drive unit include a hydraulic motor, an electric motor, or an engine. A driver may also include gearboxes, belts, chain drives, or other power transmission devices.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination or in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

1. An intermediate refuse collection system, comprising:
a support structure comprising a base, the base configured to couple with a lift of a refuse collection vehicle;
a removable collection bin coupled to the support structure, the removable collection bin comprising a polymeric material;
a refuse loading mechanism coupled to the support structure, the refuse loading mechanism operable to transfer refuse into the removable collection bin;
a control system coupled to the support structure and configurable to operate the refuse loading mechanism; and
one or more power supply devices coupled to the support structure and configured to supply power to the refuse loading mechanism.

2. The intermediate refuse collection system of claim 1, wherein:
the refuse loading mechanism comprises one or more electric drive units; and
at least one of the power supply devices comprises a battery configured to supply electric power to at least one of the electric drive units.

3. The intermediate refuse collection system of claim 1, wherein the refuse loading mechanism is configured to lift a waste container and empty contents of the waste container into the removable collection bin.

4. The intermediate refuse collection system of claim 1, wherein:
the base comprises one or more pockets; and
each of at least two of the pockets is configured to receive a fork of the lift.

5. The intermediate refuse collection system of claim 1, wherein the lift comprises a front-end loading arm assembly configured to empty contents of the removable collection bin into a vehicle container.

6. The intermediate refuse collection system of claim 1, further comprising a propping device configured to raise at least a portion of the base off the ground when the base is resting on the ground.

7. A method of collecting refuse, comprising:
operating a refuse collection vehicle to engage a base of an intermediate refuse collection system with a lift of the refuse collection vehicle;
supplying electric power from the intermediate refuse collection system to a refuse a refuse loading mechanism of the intermediate refuse collection system; and
operating the refuse loading mechanism to load refuse into a removable collection bin coupled to the base.

8. The method of claim 7, wherein at least a portion of the removable collection bin comprises a polymeric material.

9. The method of claim 7, further comprising operating the lift to transfer contents from the removable collection bin into a vehicle container.

10. The method of claim 7, further comprising removing the removable collection bin from the base and replacing the removable collection bin with another collection bin.

11. The method of claim 7, further comprising, before engaging the base with the lift, operating a propping device to prop at least a portion of the base above a ground surface.

12. The method of claim 7, further comprising:
disengaging the base from the lift of the refuse collection vehicle.

13. The method of claim 12, further comprising, before disengaging the base from the lift, operating a propping device to prop at least a portion of the base above a ground surface.

14. The method of claim 12, further comprising, after disengaging the base from the lift, operating the refuse loading mechanism.

15. An intermediate refuse collection system, comprising:
a support structure comprising a base, the base configured to couple with a lift of a refuse collection vehicle;
a collection bin coupled to the support structure; and
a propping device configured to prop at least a portion of the base off the ground when the base is resting on the ground.

16. The intermediate refuse collection system of claim 15, further comprising a propping device coupled to the base, wherein the propping device is operable by a user to raise at least a portion of the base off the ground.

17. The intermediate refuse collection system of claim 15, wherein the propping device comprises one or more retractable support brackets.

18. The intermediate refuse collection system of claim 17, further comprising a drive unit configured to move at least one of the one or more retractable support brackets.

19. The intermediate refuse collection system of claim 15, wherein the propping device comprises one or more arms configured to rotate with respect to the base such that at least a portion of the base is raised off the ground.

20. The intermediate refuse collection system of claim 15, wherein:
the base comprises one or more pockets; and
each of at least two of the pockets is configured to receive a fork of the lift.

21. The intermediate refuse collection system of claim 15, wherein the lift comprises a front-end loading arm assembly configured to empty contents of the collection bin into a vehicle container.

22. A method of engaging a lift of a refuse collection vehicle with an intermediate collection system, comprising:
operating a propping device on coupled to a base of the intermediate collection system to raise at least a portion of the base off the ground; and
operating, while the propping device holds the at least a portion of the base off the ground, the refuse collection vehicle to engage the lift with the base.

23. The method of claim 22, further comprising raising at least a portion of the base off the ground comprises inclining the base at an angle relative to the ground.
